(19) United States
(12) Patent Application Publication
(10) Pub. No.: US 2014/0099811 A1
(43) Pub. Date: Apr. 10, 2014

(54) Electrical Connector Assembly

(71) Applicant: Asian Power Devices Inc., Taoyuan City (TW)

(72) Inventor: Chui-Hsing Chiu, Taoyuan City (TW)

(21) Appl. No.: 13/926,163

(22) Filed: Jun. 25, 2013

(30) Foreign Application Priority Data
Oct. 4, 2012 (TW) 101219282

(51) Int. Cl. H01R 13/52

(52) U.S. Cl. CPC H01R 13/5205
USPC 439/275

(57) ABSTRACT

An electrical connector assembly comprises: a first connecting member, which comprises: a first insulating member, forming a first indentation and a second indentation, the second indentation surrounding the first indentation; a first conducting member, disposing in the first indentation; a waterproof collar, disposing in the second indentation; a second connecting member, comprising: a second insulating member; a first convex portion, connecting with the second insulating member and corresponding to the first indentation, the first convex portion forming a third indentation; a second conducting member, corresponding to the first conducting member and disposing in the third indentation; and a second convex portion, connecting with the second insulating member and corresponding to the second indentation; wherein while the first connecting member connects with the second connecting member, the second convex portion urges the waterproof collar, and the first conducting member electrically connects with the second conducting member.

### BACKGROUND OF THE INVENTION

1. Field of the Invention

The present invention generally relates to an electrical connector assembly, more particularly to an electrical connector assembly that is waterproof.

2. Description of the Prior Art

Electrical connector assembly is to electrically connect two devices, so that electrical power or signals can be transmitted from one to another. However, if the electrical connector assembly may not equip with a waterproof structure, then the water (or water vapor) is easy to penetrate the electrical connector assembly to cause leakage of electricity.

Taiwan Patent, Publication No. M267716, discloses an AC power plug and a waterproof structure of a socket. The patent adopts a ring fastening component to rotate in order to let the plug close the socket. Hence a waterproof collar (generally called O-ring) is axially urged for waterproof. However, the waterproof structure shall be additionally added a single fastening component, so it is difficult to reduce the overall costs.

Taiwan Patent, Publication No. M432982, discloses a waterproof connector, which configures a waterproof collar on the ring groove of the cylinder of a plug, and then the inner wall of a socket is used to radially urge the waterproof collar. However, while inserting and pulling out the waterproof connector, the inner wall of the socket may rub against the waterproof collar to cause the abrasion of the waterproof collar. So, after a number of inserting and pulling out, the waterproof collar may not work properly.

### SUMMARY OF THE INVENTION

The main objective of the present invention is to provide an electrical connector assembly that has a simpler structure and a better waterproof effect.

To approach above objective, the electrical connector assembly of the present invention comprises a first connecting member, a waterproof collar and a second conducting member. The first connecting member comprises a first insulating member and a first conducting member, wherein the first insulating member forms a first indentation and a second indentation, the second indentation surrounds the first indentation, the first conducting member disposes in the first indentation, the waterproof collar disposes in the second indentation.

Accordingly, a second connecting member comprises a second insulating member, a first convex portion, a second conducting member, and a second convex portion. The first convex portion and the second convex portion connect with the second insulating member and respectively correspond to the first indentation and the second indentation, wherein the first convex portion forms a third indentation, the second conducting member corresponding to the first conducting member disposes in the third indentation.

While the first connecting member connects with the second connecting member, the second convex portion urges the waterproof collar, and the first conducting member electrically connects with the second conducting member.

For a preferred embodiment, the first connecting member further comprises a first buckle portion, and the second connecting member further comprises a second buckle portion. While the first connecting member connects with the second connecting member, the first buckle portion buckles up the second buckle portion.

For another embodiment, a contact angle is between a normal of a plane of the waterproof collar urged by the second convex portion and the axial direction of the connector assembly. The contact angle is between 10° and 30°, and 15° is preferred. The deformation of the second convex portion urging the waterproof collar is between 10% and 30%, and 20% is preferred.

As a conclusion, the waterproof collar is axially urged, so that the waterproof collar is only pressed, but not rubbed. Therefore, the life of the waterproof collar is effectively increased.

### BRIEF DESCRIPTION OF THE DRAWINGS

The objects, spirits, and advantages of the preferred embodiments of the present invention will be readily understood by the accompanying drawings and detailed descriptions, wherein:

FIG. 1A and FIG. 1B illustrate a schematic 3-D exploded view and a schematic 3-D assembled view of an embodiment of the electrical connector assembly of the present invention;

FIG. 1C and 1E illustrate schematic sectional views of different viewing angles of FIG. 1A;

FIG. 1D and FIG. 1F illustrate schematic sectional views of different viewing angles of FIG. 1B;

FIG. 1G is a partial amplified view of the electrical connector assembly of FIG. 1F;

FIG. 1H is a partial amplified view of another embodiment of the electrical connector assembly of the present invention;

FIG. 2A illustrates a schematic 3-D exploded view of another embodiment of the electrical connector assembly of the present invention; and

FIG. 2B and FIG. 2C illustrate schematic sectional views of different viewing angles of FIG. 2A of the embodiment of the electrical connector assembly of the present invention.

### DETAILED DESCRIPTION OF THE INVENTION

Following preferred embodiments and figures will be described in detail so as to achieve aforesaid objects.

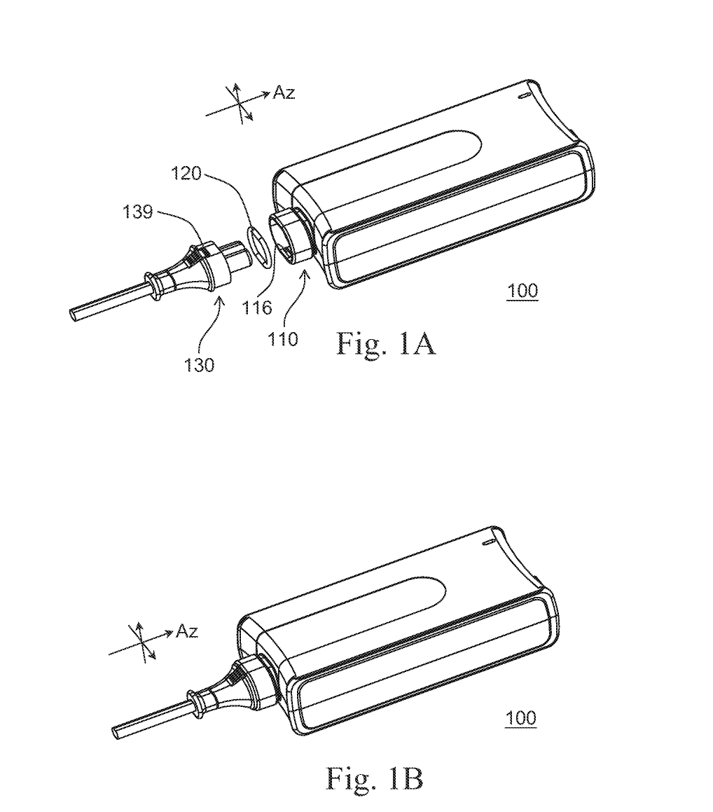

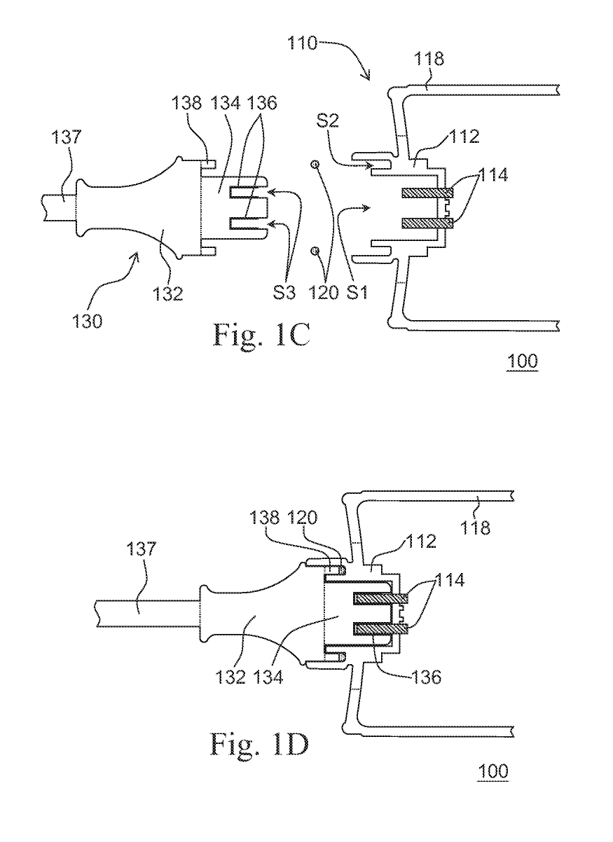

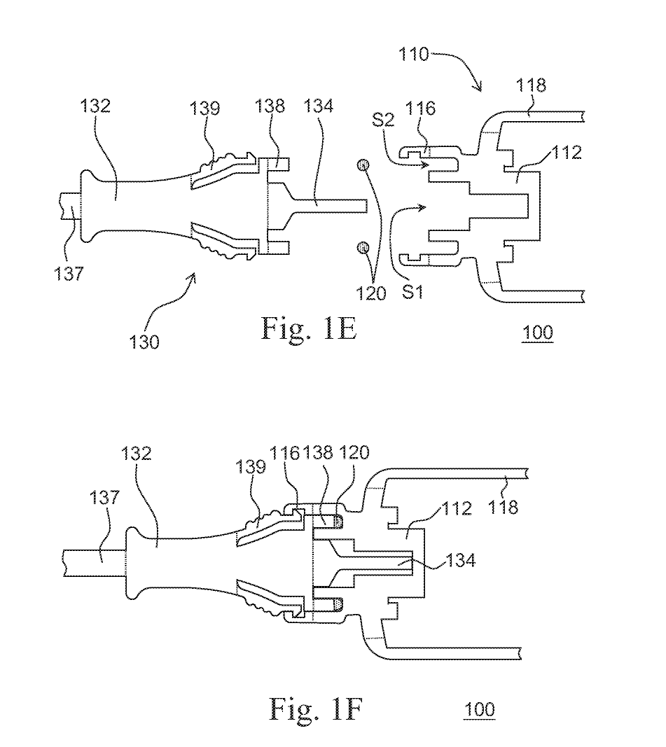

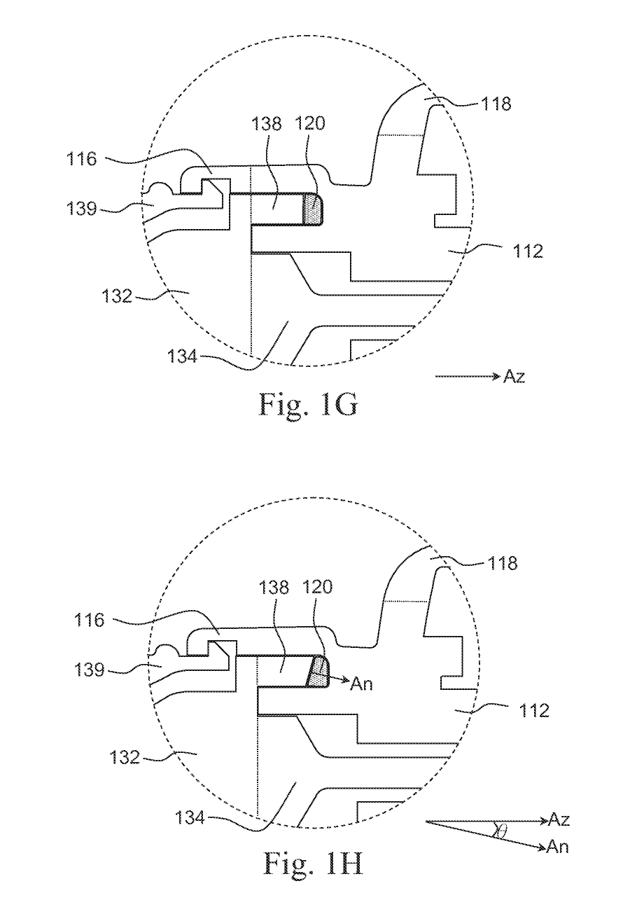

With reference to FIG. 1A and FIG. 1B, which illustrate a schematic 3-D exploded view of an embodiment of the electrical connector assembly of the present invention and a schematic 3-D assembled view of the embodiment of the electrical connector assembly of the present invention. With reference to FIG. 1C and 1E, which illustrate a schematic sectional view of a viewing angle of FIG. 1A of the embodiment of the electrical connector assembly of the present invention and a schematic sectional view of another viewing angle of FIG. 1A of the embodiment of the electrical connector assembly of the present invention. With reference to FIG. 1D and FIG. 1F, which illustrate a schematic sectional view of a viewing angle of FIG. 1B of the embodiment of the electrical connector assembly of the present invention and a schematic sectional view of another viewing angle of FIG. 1B of the embodiment of the electrical connector assembly of the present invention.

Please refer to FIG. 1A to FIG. 1F, a electrical connector assembly 100 of the present invention has a first connecting member 110, a waterproof collar 120 and a second connecting member 130. The first connecting member 110 has a first insulating member 112 and a first conducting member 114, wherein the first insulating member 112 forms a first indentation S1 and a second indentation S2, so as to respectively accommodate the first conducting member 114 and the waterproof collar 120.

Under the viewing angle of an axial direction Az, the second indentation S2 surrounds the first indentation S1 in order to let the first indentation S1 be at the inner side of the second indentation S2. Hence, if the waterproof collar 120 of the second indentation S2 is tightly urged, water will be blocked out the second indentation S2, and therefore water may not leak into the first indentation S1 to affect the first conducting member 114.

Accordingly, the second connecting member 130 has a second insulating member 132, a first convex portion 134, a second conducting member 136, and a second convex portion 138. The first convex portion 134 and the second convex portion 138 connect with the second insulating member 132 and respectively correspond to the first indentation S1 and the second indentation S2.

In addition, the first convex portion 134 forms a third indentation S3. The second conducting member 136 corresponding to the first conducting member 114 disposes in the third indentation S3. While the first connecting member 110 connects with the second connecting member 120, the first conducting member 114 may urge the second conducting member 136, so that the first conducting member 114 electrically connects with the second conducting member 136 for transmitting electric power or signals.

For the embodiment, the first conducting member 114 is a copper stud, the second conducting member 136 is a metal shrapnel. Through the flexible force of the metal shrapnel, the copper stud is tightly fastened, so as to achieve outstanding conductive characteristic. The present invention may not limit the patterns of the first conducting member 114 and the second conducting member 136.

In addition, while the first connecting member 110 connects with the second connecting member 130, the second convex portion 138 may get into the bottom of the second indentation S2 to urge the waterproof collar 120. Via the deformation of the waterproof collar 120, a gap between the second convex portion 138 and the bottom of the second indentation S2 may be filled out so as to not let water out the second indentation S2 gets into the second indentation S2 for waterproof.

Please refer to FIG. 1A to FIG. 1F, while the first connecting member 110 connects with the second connecting member 130 and to make a user to assure that the second convex portion 138 had gotten into the bottom of the second indentation S2 to urge the waterproof collar 120 is a must, the present invention is able to add a fastening structure, so that the user may feel that the connection is finished by hands.

Specifically, the first connecting member 110 further comprises a first buckle portion 116 and the second connecting member 130 further comprises a second buckle portion 139 corresponding to the buckle portion 116, the first buckle portion 116 fastens the second buckle portion 139 while the first connecting member 110 connects with the second connecting member 130, so that the user may assure the connection is finished.

For the embodiment, a hook assembly is consisted of the first buckle portion 116 and the second buckle portion 139, wherein the first buckle portion 116 is a buckle hook and the second buckle portion 139 is a buckle open, and the buckle hook hooks the buckle open so as to let the first connecting member 110 and the second connecting member 130 be fastened tightly. While the first buckle portion 116 is pressed down, the buckle hook gets off the buckle open, so that the user easily separates the first connecting member 110 and the second connecting member 130.

It is to be noted that the present invention may not limit the patterns of the first buckle portion 116 and the second buckle portion 139. Following text may take other patterns of the first buckle portion 116 and the second buckle portion 139.

Additionally, the present invention may not limit the patterns of the first connecting member 110 and the second connecting member 130. For the embodiment, the first connecting member 110 further comprises a case 118, and there are some electronic components (not shown in figure) in the case 118. The second connecting member 130 further comprises a cable 137 that is an independent wire.

For more understanding, taking the first connecting member 110 and the second connecting member 130 apart is to define the connection relationships of those parts. Persons who are skilled in the art may understand such parts are independent units or integrated units.

For the embodiment, the first insulating member 112, the first buckle portion 116 and the case 118 are integrated plastic structure. The second insulating member 132, the first convex portion 134, the second convex portion 138, the second buckle portion 139, and the cable 137 are integrated plastic structure as well. However, the present invention may not limit those parts.

FIG. 1G is a partial amplified view of the electrical connector assembly of FIG. 1F. FIG. 1H is a partial amplified view of another embodiment of the electrical connector assembly of the present invention. For convenience, same part will be with the same number. Please refer to FIG. 1G, in the electrical connector assembly 100, a plane of the waterproof collar 120 urged by the second convex portion 138 is perpendicular to the axial direction Az of the electrical connector assembly 100. That is, the waterproof collar 120 accepts the squeeze of the deformation of the second convex portion 138 along the axial direction thereof.

Please refer to FIG. 1H, the electrical connector assembly 100a of the present embodiment is similar to the electrical connector assembly 100 of FIG. 1G. The difference is that a contact angle θ is between a normal An of a plane of the waterproof collar 120 urged by the second convex portion 138a and the axial direction Az of the electrical connector assembly 100.

Therefore, the waterproof collar 120 accepts the squeeze of the deformation of the second convex portion 138 along the axial direction and the radial direction thereof, so as to promote the effect of waterproof. After plural times of determinations, the contact angle θ between 10° and 30° may be better to waterproof; the contact angle θ being 15 ° is the best to waterproof, and the electrical connector assembly 100a generally approaches the waterproof level of IPX2 or over.

In addition, the contact angle θ to one of the factors to define the relationships of the second convex portion 138a and the waterproof collar 120, and another factor is to adopt the deformation of the waterproof collar 120 to define the design of the second convex portion 138a.

While the deformation of the waterproof collar 120 is between 10% and 30%, the waterproof is better. In detail, while the deformation of the waterproof collar 120 is 20%, the waterproof is the best in reliability verification.

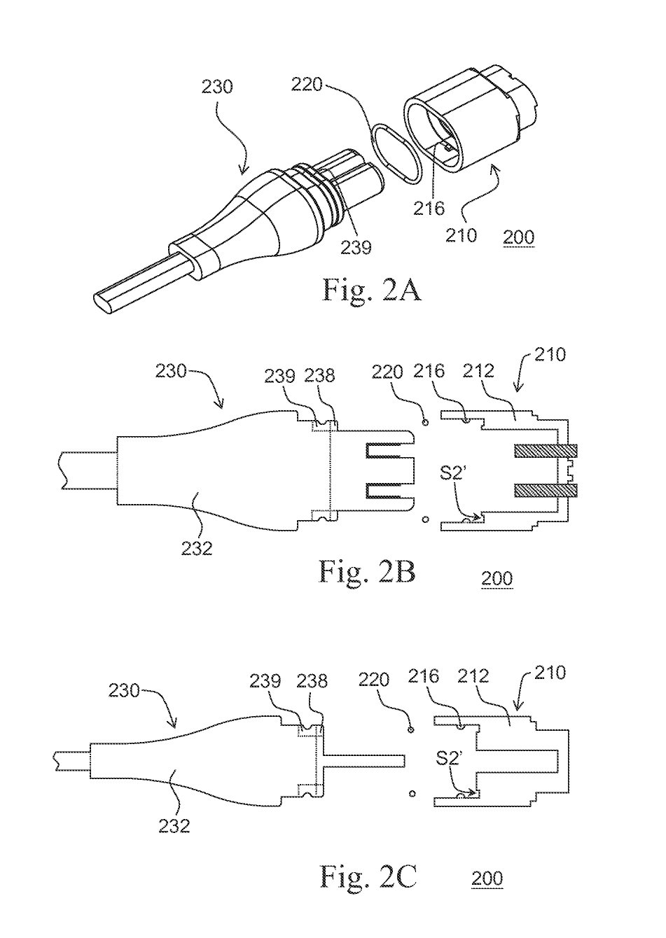

FIG. 2A illustrates a schematic 3-D exploded view of another embodiment of the electrical connector assembly of the present invention. FIG. 2B and FIG. 2C illustrate schematic sectional views of different viewing angles of FIG. 2A of the embodiment of the electrical connector assembly of the present invention. As shown from FIG. 2A to FIG. 2C, the electrical connector assembly 200 of the embodiment is similar to the electrical connector assembly 100 (as shown from FIG. 1A to FIG. 1F). The pattern of the first buckle portion 216 and the second buckle portion 239 differ from the first buckle portion 116 and the second buckle portion 139 of aforesaid embodiment (as shown from FIG. 1A to FIG. 1F).

Specifically, the first buckle portion 216 of the first connecting member 210 of the electrical connector assembly 200 forms a convex block on the first insulating member 212 and the second buckle portion 239 of the second connecting member 230 of the electrical connector assembly 200 forms a sunken area on the second insulating member 232.

While the first connecting member 210 connects with the second connecting member 230, the first buckle portion 216 interferes the second insulating member 232, so as to cause the deformation of the inner wall of the second insulating member 232. While the first buckle portion 216 buckles up the second buckle portion 239, the user may feel that the connection is finished by hands.

It is to be noted that the present invention may not limit the pattern of the second convex portion 238, and the second convex portion 238 is corresponding to the shape of the second indentation S′ so as to let the waterproof collar 220 be tightly urged by the second convex portion 238 in the second indentation S′ for waterproof.

For the embodiment, the depth of the second indentation S2′ is slightly smaller than the diameter of the waterproof collar 220. The second convex portion 238 just covers on the second indentation S2′ in order to completely urge the waterproof collar 220 into the second indentation S2′. Persons who are skilled in the art may slightly vary the pattern of the second convex portion 238, and it is still in the scope of the present invention.

Compared to prior arts, the electrical connector assembly of the present invention may have the advantages listed below:
1. The electrical connector assembly mainly is consisted of two members that are connected to each other in two opposite directions in order to clamp the waterproof collar. The present invention shall not equip with a ring fastening component in order to save cost compared to prior arts.
2. The waterproof collar is axially urged, so that the waterproof collar is only pressed, but not rubbed. Therefore, the life of the waterproof collar is effectively increased.
3. The present invention adopts the second convex portion with different angles of planes to urge the waterproof collar in order to apply the axial forces and the radial forces to the waterproof collar simultaneously for a better waterproof effect.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A electrical connector assembly comprising:
a first connecting member (110), comprising:
a first insulating member (112), forming a first indentation (S1) and a second indentation (S2), the second indentation (S2) surrounding the first indentation (S1);
a first conducting member (114), disposing in the first indentation (S1);
a waterproof collar (120), disposing in the second indentation (S2);
a second connecting member (130), comprising:
a second insulating member (132);
a first convex portion (134), connecting with the second insulating member (132) and corresponding to the first indentation (S1), the first convex portion (134) forming a third indentation (S3);
a second conducting member (136), corresponding to the first conducting member (114) and disposing in the third indentation (S3); and
a second convex portion (138), connecting with the second insulating member (132) and corresponding to the second indentation (S2);
wherein while the first connecting member (110) connects with the second connecting member (130), the second convex portion (138) urges the waterproof collar (120), and the first conducting member (114) electrically connects with the second conducting member (136).

2. The electrical connector assembly according to claim 1, wherein the first connecting member (110) further comprises a first buckle portion (116) and the second connecting member (130) further comprises a second buckle portion (139), the first buckle portion (116) fastening the second buckle portion (139) while the first connecting member (110) connects with the second connecting member (130).

3. The electrical connector assembly according to claim 2, wherein a hook assembly comprises the first buckle portion (116) and the second buckle portion (139), the first buckle portion (116) connecting with the first insulating member (112), the second buckle portion (139) connecting with the second insulating member (132).

4. The electrical connector assembly according to claim 2, wherein the first buckle portion (116) forms a convex block on the first insulating member (112) and the second buckle portion 139 forms a sunken area on the second insulating member (132).

5. The electrical connector assembly according to claim 2, wherein a plane of the waterproof collar (120) urged by the second convex portion (138) is perpendicular to the axial direction (Az) of the electrical connector assembly (100).

6. The electrical connector assembly according to claim 2, wherein a contact angle (θ) is between a normal of a plane (An) of the waterproof collar (120) urged by the second convex portion (138) and the axial direction (Az) of the electrical connector assembly (100).

7. The electrical connector assembly according to claim 6, wherein the contact angle (θ) is between 10° and 30°.

8. The electrical connector assembly according to claim 7, wherein the contact angle (θ) is 15°.

9. The electrical connector assembly according to claim 6, wherein the deformation of the second convex portion (138) urging the waterproof collar (120) is between 10% and 30%.

10. The electrical connector assembly according to claim 9, wherein the deformation of the second convex portion (138) urging the waterproof collar (120) is 20%.
